(19) United States
(12) Patent Application Publication
(10) Pub. No.: US 2026/0300181 A1
(43) Pub. Date: Oct. 1, 2026

(54) CACHING AND PREFETCH FOR MEMORY SYSTEM READ OPERATION

(71) Applicant: Micron Technology, Inc., Boise, ID (US)

(72) Inventor: Charles Henry, Mead, CO (US)

(21) Appl. No.: 19/091,536

(22) Filed: Mar. 26, 2025

(51) Int. Cl. G06F 12/0862

(52) U.S. Cl. CPC G06F 12/0862

(57) ABSTRACT

Various example embodiments provide prefetching and caching data for read operations on a memory system, such as a memory sub-system. In particular, some example embodiments transfer prefetched data from a memory system to a pool of host memory locations on a host system prior to the host system requesting the data. Once the prefetched data is stored in the pool of host memory locations, the pool can serve as a local cache on the host system that can readily provide a software application on the host system with requested data without a read request to the memory system if the data is present in the pool and, if not, the host system can request the data from the memory system.

### TECHNICAL FIELD

Example embodiments of the disclosure relate generally to memory devices and, more specifically, to prefetching and caching data for read operations on a memory system, such as a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various example embodiments of the disclosure. The drawings, however, should not be taken to limit the disclosure to the specific example embodiments, but are for explanation and understanding only.

FIG. 1 is a block diagram illustrating an example computing system that includes a memory sub-system, in accordance with some example embodiments of the present disclosure.

FIGS. 2 through 4 are flow diagrams of example methods for prefetching and caching data for read operations on a memory system, in accordance with some example embodiments of the present disclosure.

FIGS. 5A and 5B provide an interaction diagram illustrating interactions between components of a computing environment in the context of some example embodiments in which a method for prefetching and caching data for read operations on a memory system as described herein is performed.

FIG. 6 is a block diagram of an example computer system in which example embodiments of the present disclosure may operate.

### DETAILED DESCRIPTION

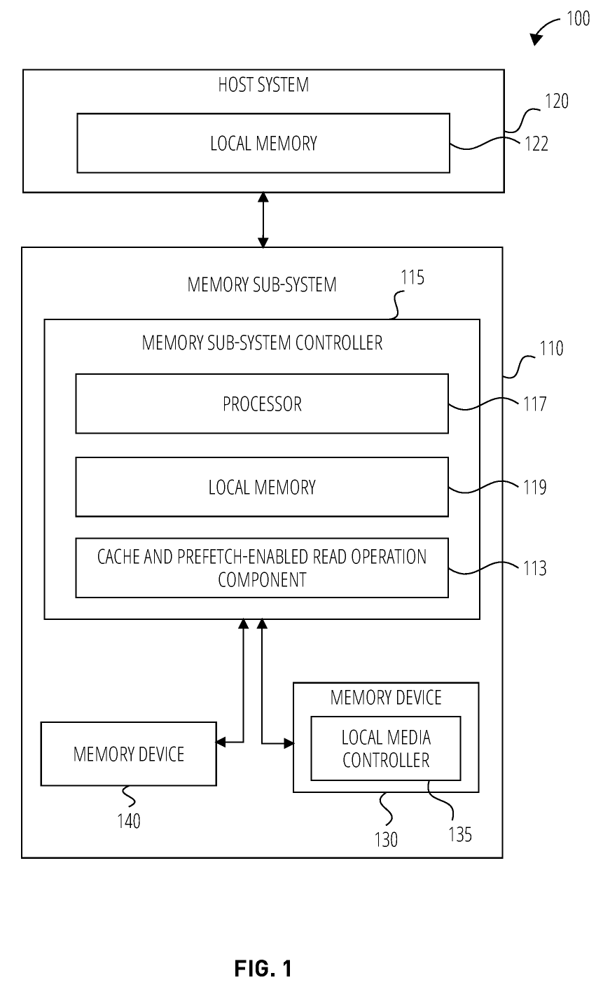

Aspects of the present disclosure are directed to prefetching and caching data for read operations on a memory system, such as a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write command, read command) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request, is hereinafter referred to as “host data” or “user data.”

A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., error-correcting code (ECC) code word, parity code), data version (e.g., used to distinguish age of data written), valid bitmap (which LBAs or logical transfer units contain valid data), and so forth.

As used herein, a logical memory address can comprise a logical block address (LBA), which can be provided by a host system to a memory device or a memory sub-system. For example, depending on a physical interface used between a host system and a memory device/memory sub-system, an LBA can comprise a 2-byte or 4-byte number. As used herein, a physical memory address can comprise a memory address on a memory device or a memory sub-system where data (e.g., user data) is stored. For example, the physical memory address can comprise a physical block address (PBA), which can be a position within an underling non-volatile memory device that can be identified by a 4-byte number or a tuple of numbers (e.g. die ID, block ID, page ID). As used herein, an address mapping data can comprise logical memory address-to-physical memory address (L2P) data (e.g., L2P mapping or translation table), which can associate (and therefore facilitate translation or reconstruction of) a logical memory address to a physical memory address of a memory device or a memory sub-system.

The memory sub-system can initiate media management operations, such as a write operation, on host data that is stored on a memory device. For example, firmware of the memory sub-system may re-write previously written host data from a location of a memory device to a new location as part of garbage collection management operations. The data that is re-written, for example as initiated by the firmware, is hereinafter referred to as “garbage collection data.”

“User data” hereinafter generally refers to host data and garbage collection data. “System data” hereinafter refers to data that is created and/or maintained by the memory sub-system for performing operations in response to host requests and for media management. Examples of system data include, and are not limited to, system tables (e.g., logical-to-physical memory address mapping table (also referred to herein as a L2P table), data from logging, scratch pad data, and so forth).

A memory device can be a non-volatile memory device. A non-volatile memory device is a package of one or more die. Each die can be comprised of one or more planes. For some types of non-volatile memory devices (e.g., AND-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are a raw memory device combined with a local embedded controller for memory management within the same memory device package.

Generally, writing data to NAND-type memory devices involves programming (by way of a program operation) the NAND-type memory devices at the page level of a block, and erasing data from such memory devices involves erasing the memory devices at the block level (e.g., page level erasure of data is not possible). Certain memory devices, such as NAND-type memory devices, comprise one or more blocks, (e.g., multiple blocks) with each of those blocks comprising multiple pages, where each page comprises a subset of memory cells of the block, and where a single wordline of a block (which connects a group of memory cells of the block together) defines one or more pages of a block (depending on the type of memory cell). Depending on the embodiment, different blocks can comprise different types of memory cells. For instance, a block (a single-level cell (SLC) block) can comprise multiple SLCs, a block (a multi-level cell (MLC) block) can comprise multiple MLCs, a block (a triple-level cell (TLC) block) can comprise multiple TLCs, a block (a quad-level cell (QLC) block) can comprise QLCs, and a block (a penta-level cell (PLC) block) can comprise PLCs. Other blocks comprising other types of memory cells (e.g., higher-level memory cells, having higher bit storage-per-cell) are also possible.

Data transfer between memory systems and host systems often involves managing read operations and data access patterns. Memory systems, such as SSDs, communicate with host systems through standardized interfaces and protocols, such as one defined by a Non-Volatile Memory Express (NVMe) standard or specification. These interfaces enable data transfer between the storage device's non-volatile memory and the host system's volatile memory. The process typically involves the host system requesting data through a memory system software driver, which then coordinates with the memory system to retrieve the requested data. Memory systems employ various mechanisms to handle read requests, including pattern detection and data buffering, to facilitate data transfers between the data storage media and the host system's volatile memory.

Various example embodiments described herein are directed to prefetching and caching data for read operations on a memory system, such as a memory sub-system. In particular, various example embodiments implement a proactive data transfer mechanism between a host system and a memory system, use pools of host memory on the host system, and use read pattern detection to reduce data access latency when the host system reads data from the memory system. For instance, some example embodiments transfer (e.g., via direct memory access (DMA)) prefetched data (e.g., read look-ahead data) from a memory system to a pool of host memory locations on a host system prior to the host system requesting the data. Once the prefetched data is stored in the pool of host memory locations, the pool can serve as a local cache that can readily provide a software application on the host system with requested data without a read request to the memory system if the data is present in the pool and, if not, the host system can request the data from the memory system. Additionally, some example embodiments provide a memory system with a means of communicating (e.g., notifying) the host system when prefetched data is available in the pool of host memory locations (e.g., notification through a completion queue or through an asynchronous means). Use of some example embodiments can basically extend existing prefetch or read look-ahead processes by pushing read data into a host system's local memory prior to the host system request the data based on discovered workload patterns (e.g., read patterns) by the memory system.

According to various example embodiments, a memory system comprises a memory device and a processing device that coordinates data transfers with a host system. The processing device can receive configuration information from the host system that defines a pool of host memory locations on local memory (e.g., RAM) of the host system, where these memory locations are reserved on the host system's local memory for temporary storage of data prefetched and transferred to the host system from the memory system. During operation, the host system can initiate the process by sending one or more configuration commands to establish the pool of host memory locations. These commands can take various forms, such as a set feature command in NVMe implementations or the like. The memory system can validate the configuration and store information about the accessible pool of host memory locations. When the host system requests data, the memory system reads the data from one or more specified logical memory addresses (e.g., LBAs) and transfers the data to the host system using a direct memory access (DMA) mechanism/process. The completion of this request can be signaled to the host system by the memory system through a completion queue entry.

On the memory system, a read pattern detection mechanism can monitor these read operations being performed on the memory system. The read pattern detection can use built-in capabilities, such as a read look-ahead process or a stream detection process. In some example embodiments, the host system can provide hints about data relationships through mechanisms such as stream directives. Upon detecting a read pattern, the memory system can initiate a prefetch operation, where the memory system can read additional data from memory locations that correspond to predicted future read requests. This prefetched data can be transferred directly to allocated locations within the pool of host memory locations.

To notify the host about prefetched data newly stored in the pool of host memory locations, the memory system can send an asynchronous notification of data availability. When the host system requests data already stored in the pool of host memory locations, a memory system software drive on the host system can provide the requested data from the pool of host memory locations(e.g., by responding to the request with location information for the stored in the pool of host memory locations). Host-side software components can manage access to prefetched data in the pool of host memory locations. For instance, a host-side memory system driver can search (e.g., check) the pool of host memory locations for requested data (e.g., requested by a host-side software application) before issuing new read commands to the memory system. When matching prefetched data is found in the pool of host memory locations, the host-side memory system data driver can return the matching prefetched data to the host-side software application immediately without requiring additional memory system access. With respect to management of the pool of host memory locations, the host system can release memory locations in the pool for reuse and inform the memory system of such (e.g., via a notification). Additionally, the memory system can invalidate memory location in the pool of host memory locations when the memory system determines that the memory location is storing stale data. In such instances, the memory system can send a notification to the host system regarding the invalidated memory location.

Though various example embodiments are described herein with respect to a memory system that implements an interface according to a NVMe standard/specification, such example embodiment can be implemented with respect to other interface standards/specifications, such as Small Computer System Interface (SCSI) or Serial-Attached SCSI (SAS).

According to alternative example embodiments, the memory system provides a list of available memory locations and corresponding sizes from the pool of host memory locations to an existing read pattern detection mechanism before the mechanism detects any read patterns. Then , when the read pattern detection mechanism identifies a read pattern and reads data from one or more predicted memory locations, the read pattern detection mechanism can directly store the data in one or more of the pre-allocated memory locations from the provided list (rather than requiring an intermediate data transfer). After storing the prefetched data, the memory system can either proactively notify the host system about the data availability or respond to a subsequent host system request by providing information about where the prefetched data is stored in the pool of host memory locations.

By providing prefetched data in a pool of host memory locations as described herein, various example embodiments can decrease the latency of reading data from a memory system by a host system and can obviate the need for additional read command submissions by the host system to read data from the memory system (e.g., host system can avoid the need to request the data from the memory system in the first place and can avoid the latency of sending the command, the latency of transferring the data from the memory system to the host system, and the latency of completing the read command to the host system via a completion queue). Accordingly, various example embodiments provide a technical solution (e.g., of proactive data prefetch and cache mechanism) to address the technical problem/challenge of latency during memory system data read operations. Additionally, use of various example embodiments can provide a host system with control of a data prefetch mechanism on a memory system, thereby providing the host system with more flexible host use cases. Overall, various example embodiments described herein can reduce data movement operations by enabling direct placement of prefetched data into host-accessible memory locations.

As used herein, a physical memory location of a memory device (e.g., a volatile or non-volatile memory device) can comprise a block, a page, or a memory cell. For instance, where a physical memory location comprises a page or a memory cell, a set of physical memory locations can represent a single block or multiple blocks. The set of physical memory locations can be a set of contiguous physical memory locations. As used herein, storing data on one or more physical memory locations of a certain memory device (e.g., a NAND-type memory device) can comprise writing data to the one or more physical memory locations by programming one or more pages of a block with the data.

Disclosed herein are some examples of prefetching and caching data for read operations on a memory system, as described herein.

FIG. 1 illustrates an example computing system 100 that includes a memory sub-system 110, in accordance with some example embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device. The computing system 100 can be used to support or implement various types of applications, including those relating to artificial intelligence (AI).

The computing system 100 can include a host system 120 that is coupled to one or more memory sub-systems 110. In some example embodiments, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

As shown, the host system 120 includes a local memory 122, which can comprise a volatile memory device (e.g., random access memory (RAM), such as dynamic random access memory (DRAM) and synchronous dynamic random access memory (SDRAM)) configured to store instructions for performing various processes, operations, logic flows, and routines (e.g., in association with an operating system, a software application, or a software driver) on the host system 120. The local memory 119 can include memory registers storing memory pointers, data received from the memory sub-system 110 to the host system 120 (e.g., via direct memory access (DMA)), and so forth.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further use an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

The memory devices 130, 140 can include any combination of the different types of non-volatile memory devices and/or volatile memory devices. The volatile memory devices (e.g., memory device 140) can be, but are not limited to, RAM, such as DRAM and SDRAM.

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130, 140 can include one or more arrays of memory cells. One type of memory cell, for example, SLCs, can store one bit per cell. Other types of memory cells, such as MLCs, TLCs, QLCs, and penta-level cells (PLCs), can store multiple bits per cell. In some example embodiments, each of the memory devices 130, 140 can include one or more arrays of memory cells such as SLCs, MLCs, TLCs, QLCs, or any combination of such. In some example embodiments, a particular memory device can include an SLC portion, and an MLC portion, a TLC portion, or a QLC portion of memory cells. The memory cells of the memory devices 130, 140 can be grouped as pages that can refer to a logical unit of the memory device used to store data. With some types of memory (e.g., NAND), pages can be grouped to form blocks. As used herein, a block comprising SLCs can be referred to as a SLC block, a block comprising MLCs can be referred to as an MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data at the memory devices 130, 140 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some example embodiments, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another example embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, garbage collection operations, error detection and ECC operations, encryption operations, caching operations, and address translations between a logical address (e.g., LBA, namespace) and a physical memory address (e.g., physical block address) that are associated with the memory devices 130, 140. The memory sub-system controller 115 can further include host interface circuitry to communicate with the host system 120 via the physical host interface. The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some example embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130, 140.

In some example embodiments, the memory device 130 includes local media controller 135 that operates in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some example embodiments, a memory device 130 is a managed memory device, which is a raw memory device combined with a local controller (e.g., local media controller 135) for media management within the same memory device package. An example of a managed memory device is a managed NAND (MNAND) device.

The memory sub-system controller 115 includes a cache and prefetch-enabled read operation component 113 that enables or facilitates prefetching and caching data for read operations on the memory sub-system 110 in accordance with various example embodiments described herein. Alternatively, some or all of the cache and prefetch-enabled read operation component 113 is included by the local media controller 135, thereby enabling the local media controller 135 to enable prefetching and caching data for read operations on the memory sub-system 110.

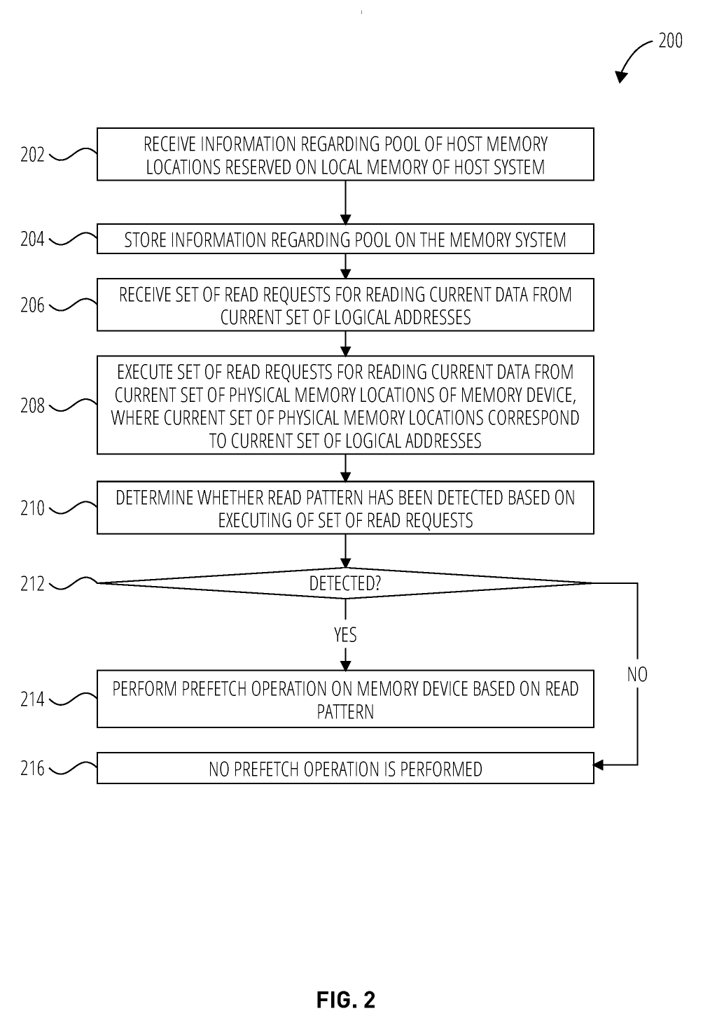

FIGS. 2 through Fig. 4 are flow diagrams of example methods 200, 300, 400 for prefetching and caching data for read operations on a memory system, in accordance with some example embodiments of the present disclosure. Any of methods 200, 300, 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some example embodiments, any of methods 200, 300, 400 is performed by the memory sub-system controller 115 of FIG. 1 based on the cache and prefetch-enabled read operation component 113. Additionally, or alternatively, for some example embodiments, any of methods 200, 300, 400 is performed, at least in part, by the local media controller 135 of the memory device 130 of FIG. 1. Although shown in a particular sequence or order, unless otherwise specified, the order of the processes can be modified. Thus, the illustrated example embodiments should be understood only as examples, and the illustrated processes can be performed in a different order, and some processes can be performed in parallel. Additionally, one or more processes can be omitted in various example embodiments. Thus, not all processes are used in every example embodiment. Other process flows are possible.

Referring now to the method 200 of FIG. 2, at operation 202, a processing device (e.g., the processor 117 of the memory sub-system controller 115) receives, from a host system (e.g., 120), information regarding (e.g., for configuring) a pool of host memory locations reserved on local memory of the host system (e.g., local memory 122 of the host system 120). In particular, the pool of host memory locations can be reserved for use by a memory system (e.g., memory sub-system 110) to push pre-fetched data to the host system prior to the host system explicitly requesting the data from the memory system (e.g., from the processor 117 of the memory sub-system controller 115). The pool of host memory locations can operate as temporary storage of the prefetched data. The pool of host memory locations can operate as a local cache of data (pre-fetched by the memory system and transferred from the memory system to the pool) that the host system (e.g., a memory system software driver thereon) can use to respond to one or more memory system read requests (e.g., that the memory system software driver receives) from a host-side software application operating on the host system. For various example embodiments, the information is received as part of a configuration command received from the host system. For example, the configuration command can be a set feature command defined by a NVMe standard or specification.

At operation 204, the processing device stores the information on the memory system (e.g., stores the information in the local memory 119 of the memory sub-system 110). For instance, the processing device can receive the configuration command, can validate the configuration command, and can then store the information from the configuration command on the memory system. Depending on the example embodiment, the information regarding the pool can comprise at least one of a start memory location (e.g., a start memory address corresponding to a start physical memory location) of the pool on the local memory of the host system or a data size of the pool. According to various example embodiments, the information enables the memory system (e.g., processor 117 of the memory sub-system controller 115) to allocate space in the pool for storing data prefetched by the memory system. Operations 202 and 204 can represent a setup/configuration process for using various example embodiments. The pool of host memory locations can be configured to align with block sizes (e.g., 4k/512 byte blocks) of the host memory (e.g., local memory 122 of the host system 120).

Subsequently, at operation 206, the processing device receives, from the host system (e.g., 120), a set of read requests for reading current data (e.g., comprising one or more blocks of data) from a current set of logical memory addresses (e.g., logical block addresses (LBAs)), where the current set of logical block address corresponds to a current set of physical memory locations of a memory device (e.g., 130, 140) of the memory system (e.g., memory sub-system 110). According to various example embodiments, the host system (e.g., 120) is operating a host-side software application that interfaces (e.g., accesses) the memory system (e.g., memory sub-system 110) via a host-side software driver, and the host-side software driver generates and sends the set of read requests to the memory system in response to: the host-side software application requesting data from the current set of logical memory addresses through the host-side software driver; and the host-side software driver searching and not finding the data from the current set of logical memory addresses in the pool of host memory locations (e.g., the host-side software driver does not have a hit in the pool with respect to the data). Alternatively, if the host-side software driver had searched and found the data from the current set of logical memory addresses in the pool of host memory locations (e.g., the host-side software driver does have a hit in the pool with respect to the data), the host-side software driver would have not have generated and sent any read requests to the memory system for the current set of logical memory addresses and, rather, would have provided the host-side software application with the data from the pool of host memory locations.

During operation 208, the processing device executes the set of read requests. Depending on read requests being generated on the host system (e.g., by a host-side software application), the set of logical memory addresses may or may not be a set of sequential logical memory addresses (e.g., sequential LBAs). The current data read from the current set of physical memory locations can be transferred to the host system using known methodologies, such as using a direct memory access (DMA) transfer from the memory system to the host system and using a completion queue in accordance with a NVMe standard or specification. Additionally, depending on the example embodiment, the current data can be transferred to the host system using direct memory access (DMA) (e.g., to a physical memory location specified by the set of read requests) and an entry can be added to a completion queue (e.g., I/O completion queue in accordance with a NVMe standard or specification) of the host system (e.g., to inform the host system that the current data has been transferred to the physical memory location).

For operation 210, the processing device determines whether a read pattern has been detected based on the executing of the set of read requests. Depending on the example embodiment, the read pattern can be detected (e.g., identified) by (e.g., using) one of several existing and known approaches for detecting a read patterns on a memory system. Examples can include both memory system-based approaches or host system-based processes. For instance, a read look-ahead is one memory system-based mechanism/process for detecting a read pattern is present. With read look-ahead, streams of data can be detected based on read requests from the host system and, based on the streams, a read pattern can be detected when the host system reads from a set of sequential logical block addresses. An example host system-based mechanism/process can include one where the host system detects a read pattern and sends a hint to the memory system to regarding the detected read pattern. When a read pattern is detected, the selected mechanism/process can inform the processing device and can provide the processing device with information regarding the read pattern, which can include a suggestion or prediction of a next set of logical block addresses that the memory system should read without explicit commands/requests from the host system to do so.

At decision block 212, in response to the processing device determining that the read pattern has been detected, method 200 proceeds to operation 214, where the processing device performs a prefetch operation on the memory device based on the read pattern. Alternatively, in response to the processing device determining that the read pattern has not been detected, method 200 proceeds to operation 216, where the processing device does not perform the prefetch operation.

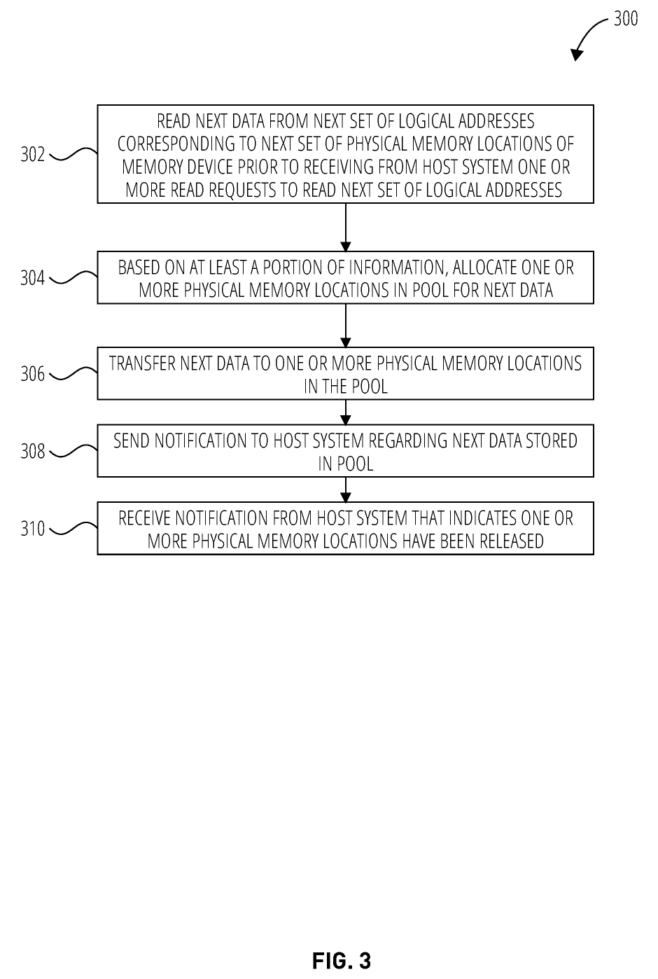

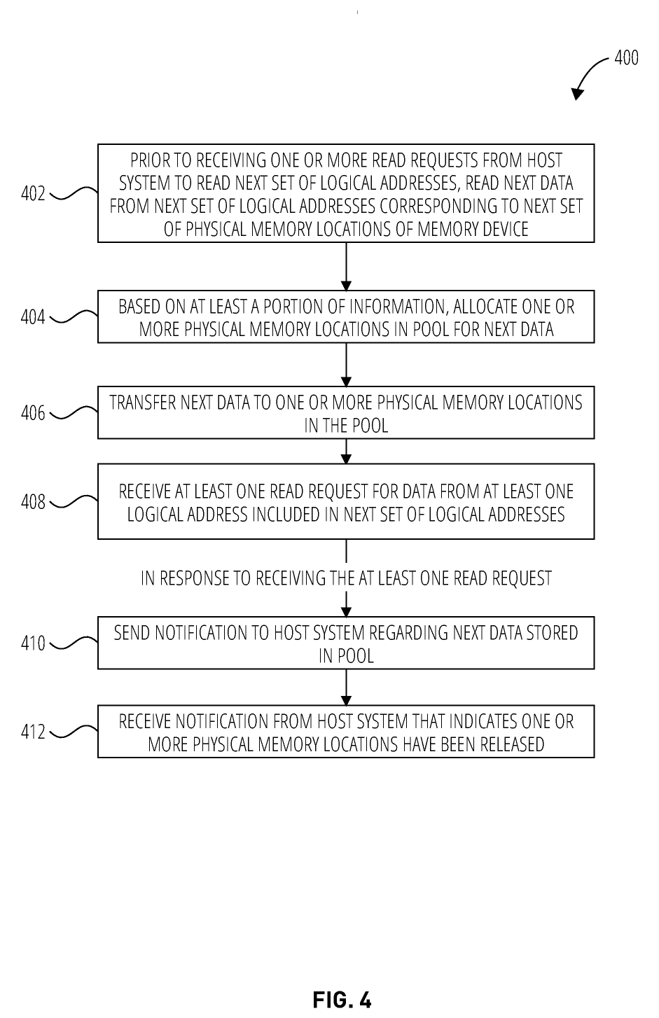

Example methods for performing the prefetch operation are illustrated and described with respect to methods 300 of FIG. 3 and method 400 of FIG. 4.

Referring now to FIG. 3, method 300 represents an example method for performing a prefetch operation, in accordance with some example embodiments of the present disclosure. At operation 302, a processing device (e.g., the processor 117 of the memory sub-system controller 115) reads next data (e.g., comprising one or more blocks of data) from a next set of logical memory addresses corresponding to a next set of physical memory locations of the memory device, where the reading is performed prior to receiving one or more read requests from the host system to read the next set of logical memory addresses. For various example embodiments, the next data is read (e.g., prefetched) into a cache of the memory system (e.g., cache provisioned in the local memory 119 of the memory sub-system controller 115).

At operation 304, the processing device allocates (e.g., selects), based on at least a portion of the information (e.g., start memory address or data size of the pool), one or more physical memory locations in the pool for the next data (e.g., to receive and store the next data). For various example embodiments, operation 304 comprises the selection of one or more unassigned physical memory locations in the pool of host memory locations.

For operation 306, the processing device transfers the next data to the one or more physical memory locations in the pool. For some example embodiments, where the next data is read (e.g., prefetched) and stored in a cache of the memory system, the next data is transferred from that cache to the pool of host memory locations. For various example embodiments, the processing device uses a direct memory access (DMA) mechanism to transfer the next data to the one or more physical memory locations in the pool, which is in the local memory of the host system (e.g., the local memory 122 of the host system 120).

After the next data is transferred to the pool, at operation 308, the processing device sends a notification to the host system (e.g., 120) regarding the next data stored in the pool. For various example embodiments, the notification indicates (to the host system) where in the pool the next data is stored by the processing device. Additionally, for some example embodiments, the notification indicates (to the host system) the next set of logical memory addresses associated with the next data transferred to the pool. Depending on the example embodiment, the notification can be sent to the host system via a completion queue (e.g., I/O submission queue in accordance with a NVMe standard or specification).

Eventually, at operation 310, the processing device receives a notification from the host system that indicates that the one or more physical memory locations in the pool of host memory locations have been released. The host system can send such a notification, for example, after the host system has read (e.g., retrieved) the next data from the pool of host memory locations. After this notification is received, the processing device can be free to reuse some or all of the one or more physical memory locations to receive new prefetched data.

A scenario can arise where the event physical memory locations corresponding to the next set of logical memory addresses are overwritten by the memory with new (e.g., updated) data, and the processing device has yet to receive a notification from the host system that the one or more physical memory locations in the pool have been released. Though not shown in FIG. 3, in such scenarios, the processing device can send another notification to the host system indicating that data stored in the one or more physical memory locations in the pool of host memory locations is now invalid (e.g., stale) due to the memory system overwrite.

Referring now to FIG. 4, method 400 represents an example method for performing a prefetch operation, in accordance with some example embodiments of the present disclosure. In comparison to method 300 of FIG. 3, method 400 represents an alternative approach for performing the prefetch operation. For various example embodiments, operations 402, 404, 406 are similar to operations 302, 304, 306 of method 300, which is illustrated and described with respect to FIG. 3.

After the transfer of the next data to the pool (at operation 406), during operation 408, the processing device receives, from the host system, at least one read request for data from at least one logical address that is included in the next set of logical memory addresses. In response, the processing device sends a notification to the host system regarding the next data stored in the pool. As described herein, the notification can indicate (to the host system) where in the pool the next data is stored by the processing device, and can indicate (to the host system) the next set of logical memory addresses associated with the next data transferred to the pool. The at least one read request can indicate (e.g., specify) one or more physical memory locations of local memory of the host system (e.g., local memory 122) where the host system expects the next data to be transferred by the memory system, and these one or more physical memory locations will likely differ from the one or more physical locations in the pool where the memory system transfers the next data. Accordingly, for some example embodiments, the notification sent to the host system (after the at least one read request is received from the host system) can be used to update the host system's expectation of where the next data is stored on the host system.

For various example embodiments, operations 410, 412 are similar to operations 308, 310 of method 300, which is illustrated and described with respect to FIG. 3.

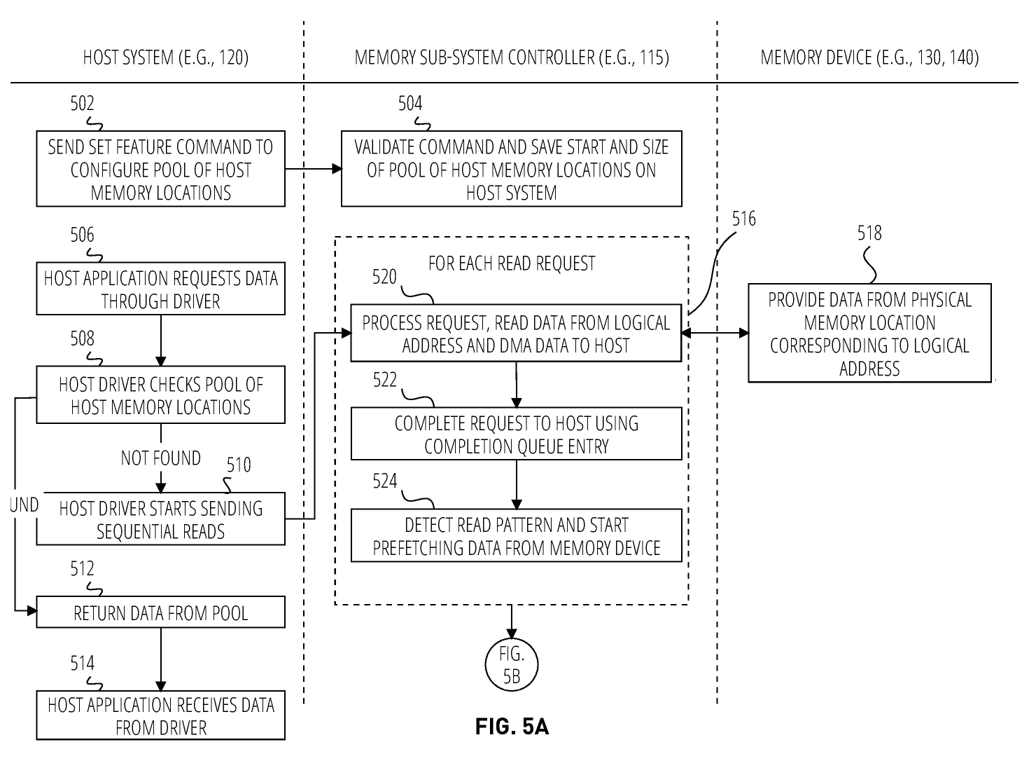

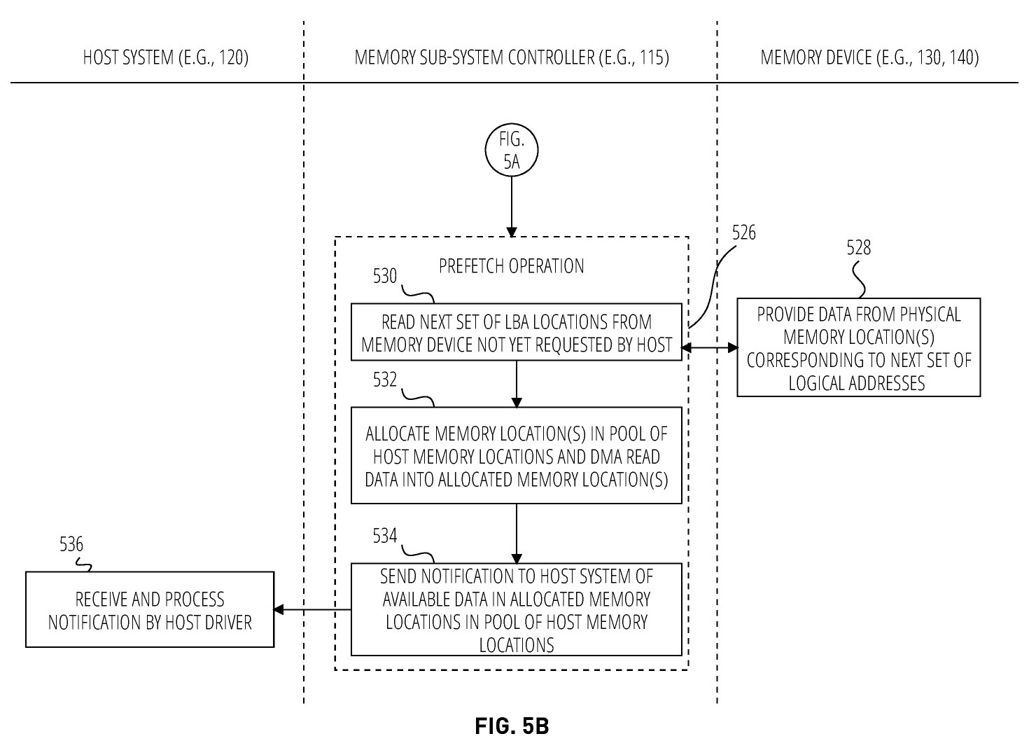

FIGS. 5A and 5B provide an interaction diagram illustrating interactions between components of a computing environment in the context of some example embodiments in which a method for prefetching and caching data for read operations on a memory system as described herein is performed. The operations of the method can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some example embodiments, the method is performed by a host system (e.g., 120), a memory sub-system controller (e.g., 115), a memory device (e.g., 130, 140), or some combination thereof. Although the operations are shown in a particular sequence or order, unless otherwise specified, the order of the processes can be modified. Thus, the illustrated example embodiments should be understood only as examples, and the illustrated processes can be performed in a different order, and some processes can be performed in parallel. Additionally, one or more processes can be omitted in various example embodiments. Thus, not all processes are used in every example embodiment. In the context of the example illustrated in FIGS. 5A and 5B, the host system can include the host system 120, the memory sub-system controller can include the memory sub-system controller 115, and the memory device can include the memory device 130.

As shown in FIG. 5A, at operation 502, the host system 120 sends a set feature command to the memory sub-system 110 to configure the memory sub-system 110 to use a pool of host memory locations on the host system 120. At operation 504, the memory sub-system controller 115 receives the set feature command, validates it, and saves a start memory location and a data size of the pool of host memory locations on the memory sub-system 110 - the pool of host memory locations represents an external memory location on the host system 120.

Eventually, at operation 506, a host software application on the host system 120 requests data through a host software driver on the host system 120 used to facilitate the host system 120's access to the memory sub-system 110. During operation 508, the host software driver checks the pool of host memory locations for the requested data. If nothing is found in the pool (e.g., no hit), at operation 510, the host software driver starts sending sequential read requests (e.g., sequential read commands) to the memory sub-system 110. However, if the host software driver find the requested data in the pool of host memory locations (e.g., there is a hit), at operation 512, the host software driver returns the requested data from the pool of host memory locations and, at operation 514, the host software application receives the requested data from the host software driver.

At operation 516, the memory sub-system controller 115 (of the memory sub-system 110) receives the sequential read requests (e.g., sequential read commands) from the host system 120, and starts processing each read request by performing operations 520, 522, 524 for each read request received from the host system 120. At operation 520, the memory sub-system controller 115 processes the read request, reads the data from a physical memory location on the memory device 130 corresponding to a logical address (e.g., LBA), and DMA transfers the read data to the host system 120. The memory device 130, at operation 518, provides the memory sub-system controller 115 with the data from a physical memory location corresponding to the logical address. At operation 522, to signal completion of the request (e.g., command), the memory sub-system controller 115 adds an entry to the host system 120's completion queue. Thereafter, the memory sub-system controller 115 may or may not detect a read pattern (e.g., using a read look-ahead process). At operation 524, the memory sub-system controller 115 detects a read pattern and starts prefetching data from the memory device 130 of the memory sub-system 110 by a prefetch operation (represented by operation 526 in FIG. 5B).

Referring now to FIG. 5B, during operation 526, the memory sub-system controller 115 performs operations 530, 532, 534. At operation 530, the memory sub-system controller 115 reads data from one or more physical memory locations on memory device 130 corresponding to a next set of logical addresses (e.g., LBAs) not yet requested to be read by the host system 120. The memory device 130, at operation 528, provides the memory sub-system controller 115 with the data from one or more physical memory locations corresponding to the next set of logical addresses. After reading the data, at operation 532, the memory sub-system controller 115 allocates one or more memory locations in the pool of host memory locations (e.g., one or more locations not yet assigned to store other prefetched data), and the memory sub-system controller 115 DMA transfers the read data into the allocated one or more memory locations in the pool. Thereafter, at operation 534, the memory sub-system controller 115 sends a notification to the host system of available (prefetched) data in the allocated one or more memory locations in the pool. At operation 536, the host software driver of the host system 120 receives and processes the notification.

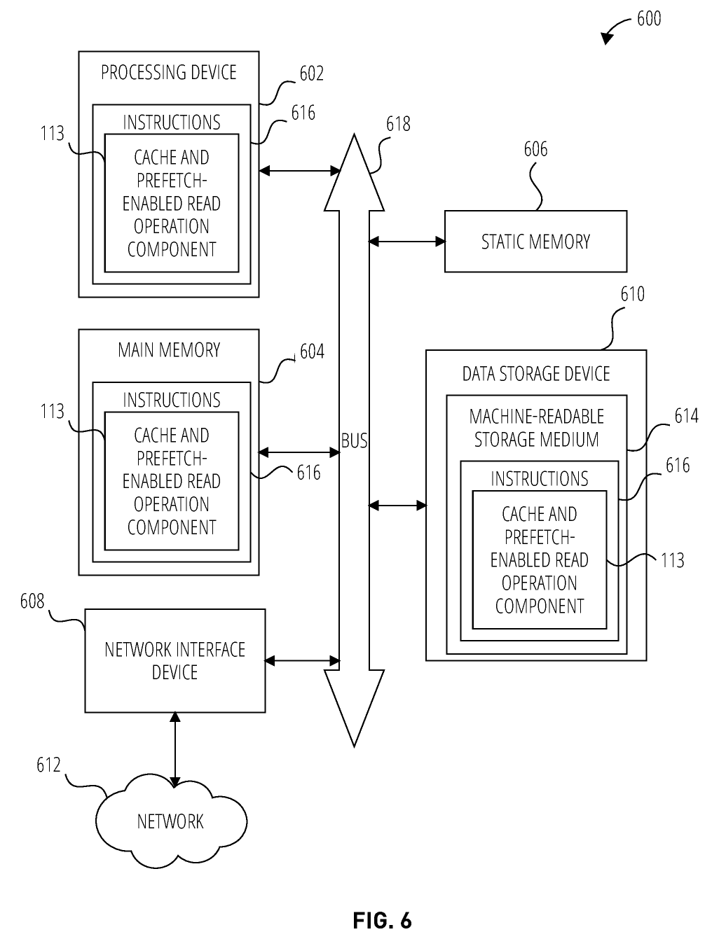

FIG. 6 illustrates an example machine in the form of a computer system 600 within which a set of instructions can be executed for causing the machine to perform any one or more of the methodologies discussed herein. In some example embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative example embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., ROM, flash memory, DRAM such as SDRAM or Rambus DRAM (RDRAM), etc.), a static memory 606 (e.g., flash memory, static random access memory (SRAM), etc.), and a data storage device 610, which communicate with each other via a bus 618.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an application-specific integrated circuit (ASIC), a field programmable gate array (FPGA), a digital signal processor (DSP), a network processor, or the like. The processing device 602 is configured to execute instructions 616 for performing the operations and steps discussed herein. The computer system 600 can further include a network interface device 608 to communicate over a network 612.

The data storage device 610 can include a machine-readable storage medium 614 (also known as a computer-readable medium) on which is stored one or more sets of instructions 616 or software embodying any one or more of the methodologies or functions described herein. The instructions 616 can also reside, completely or at least partially, within the main memory 604 and/or within the processing device 602 during execution thereof by the computer system 600, the main memory 604 and the processing device 602 also constituting machine-readable storage media. The machine-readable storage medium 614, data storage device 610, and/or main memory 604 can correspond to the memory sub-system 110 of FIG. 1.

In one example embodiment, the instructions 616 include instructions to implement functionality corresponding to prefetching and caching data for read operations on a memory system as described herein (e.g., the cache and prefetch-enabled read operation component 113 of FIG. 1). While the machine-readable storage medium 614 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.

Example 1 is a memory system comprising: a memory device; and a processing device operatively coupled to the memory device, the processing device performing operations comprising: receiving, from a host system, information regarding a pool of host memory locations reserved on local memory of the host system; executing a set of read requests for reading current data from a current set of logical memory addresses, the current set of logical address corresponding to a current set of physical memory locations of the memory device, the set of read requests being received from the host system; determining whether a read pattern has been detected based on the executing of the set of read requests; and in response to determining that the read pattern has been detected, performing a prefetch operation on the memory device based on the read pattern, the prefetch operation comprising: reading next data from a next set of logical memory addresses corresponding to a next set of physical memory locations of the memory device, the next set of logical memory addresses being determined based on the read pattern detected, the reading occurring prior to receiving one or more read requests from the host system to read the next set of logical memory addresses; based on at least a portion of the information, allocating one or more physical memory locations in the pool for the next data; and transferring the next data to the one or more physical memory locations.

In Example 2, the subject matter of Example 1 includes, wherein the read pattern is detected by a read look-ahead process.

In Example 3, the subject matter of Examples 1–2 includes, wherein the read pattern is detected by a host system-based read pattern detection process.

In Example 4, the subject matter of Examples 1–3 includes, wherein the next set of logical memory addresses is determined based on the read pattern.

In Example 5, the subject matter of Examples 1–4 includes, wherein the operations comprise: after the transferring of the next data, sending a notification to the host system regarding the next data stored in the pool.

In Example 6, the subject matter of Example 5 includes, wherein the notification indicates where in the pool the next data is stored.

In Example 7, the subject matter of Examples 5–6 includes, wherein the notification indicates the next set of logical memory addresses associated with the next data.

In Example 8, the subject matter of Examples 1–7 includes, wherein the operations comprise: after the transferring of the next data: receiving, from the host system, at least one read request for data from at least one logical address included in the next set of logical memory addresses; and in response to receiving the at least one read request, sending a notification to the host system regarding the next data stored in the pool.

In Example 9, the subject matter of Examples 1–8 includes, wherein the information regarding the pool comprises: a start memory location of the pool on the local memory of the host system; and a data size of the pool.

In Example 10, the subject matter of Examples 1–9 includes, wherein the operations comprise: storing the information on the memory system.

In Example 11, the subject matter of Examples 1–10 includes, wherein the information is received as part of a configuration command received from the host system.

In Example 12, the subject matter of Examples 1–11 includes, wherein the executing of the set of read requests for reading the current data from the current set of physical memory locations of the memory device comprises: transferring the current data to the host system using direct memory access and adding an entry to a completion queue of the host system.

In Example 13, the subject matter of Examples 1–12 includes, wherein the host system sends the set of read requests to the memory system in response to: a host-side software application requesting data from the current set of logical memory addresses through a host-side software driver to the memory system; and the host-side software driver searching and not finding the data from the current set of logical memory addresses in the pool.

Example 14 is a method to implement any of Examples 1–13.

Example 15 is at least one machine-readable medium comprising instructions that, when executed by a processing device, cause the processing device to perform operations to implement any of Examples 1–13.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (such as a non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some example embodiments, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, example embodiments of the disclosure have been described with reference to specific example embodiments thereof. It will be evident that various modifications can be made thereto without departing from the broader spirit and scope of example embodiments of the disclosure as set forth in the following claims. The specification and drawings are, accordingly, to be regarded in an illustrative sense rather than a restrictive sense.

1. A memory system comprising:
a memory device; and
a processing device operatively coupled to the memory device, the processing device performing operations comprising:
receiving, from a host system, information regarding a pool of host memory locations reserved on local memory of the host system;
executing a set of read requests for reading current data from a current set of logical memory addresses, the current set of logical address corresponding to a current set of physical memory locations of the memory device, the set of read requests being received from the host system;
determining whether a read pattern has been detected based on the executing of the set of read requests; and
in response to determining that the read pattern has been detected, performing a prefetch operation on the memory device based on the read pattern, the prefetch operation comprising:
reading next data from a next set of logical memory addresses corresponding to a next set of physical memory locations of the memory device, the next set of logical memory addresses being determined based on the read pattern detected, the reading occurring prior to receiving one or more read requests from the host system to read the next set of logical memory addresses;
based on at least a portion of the information, allocating one or more physical memory locations in the pool for the next data; and
transferring the next data to the one or more physical memory locations.

2. The memory system of claim 1, wherein the read pattern is detected by a read look-ahead process.

3. The memory system of claim 1, wherein the read pattern is detected by a host system-based read pattern detection process.

4. The memory system of claim 1, wherein the next set of logical memory addresses is determined based on the read pattern.

5. The memory system of claim 1, wherein the operations comprise:
after the transferring of the next data, sending a notification to the host system regarding the next data stored in the pool.

6. The memory system of claim 5, wherein the notification indicates where in the pool the next data is stored.

7. The memory system of claim 5, wherein the notification indicates the next set of logical memory addresses associated with the next data.

8. The memory system of claim 1, wherein the operations comprise:
after the transferring of the next data:
receiving, from the host system, at least one read request for data from at least one logical address included in the next set of logical memory addresses; and
in response to receiving the at least one read request, sending a notification to the host system regarding the next data stored in the pool.

9. The memory system of claim 1, wherein the information regarding the pool comprises:
a start memory location of the pool on the local memory of the host system; and
a data size of the pool.

10. The memory system of claim 1, wherein the operations comprise:
storing the information on the memory system.

11. The memory system of claim 1, wherein the information is received as part of a configuration command received from the host system.

12. The memory system of claim 1, wherein the executing of the set of read requests for reading the current data from the current set of physical memory locations of the memory device comprises:
transferring the current data to the host system using direct memory access and adding an entry to a completion queue of the host system.

13. The memory system of claim 1, wherein the host system sends the set of read requests to the memory system in response to:
a host-side software application requesting data from the current set of logical memory addresses through a host-side software driver to the memory system; and
the host-side software driver searching and not finding the data from the current set of logical memory addresses in the pool.

14. At least one non-transitory machine-readable storage medium comprising instructions that, when executed by a processing device of a memory system, cause the processing device to perform operations comprising:
receiving, from a host system, information regarding a pool of host memory locations reserved on local memory of the host system;
executing a set of read requests for reading current data from a current set of physical memory locations of a memory device of the memory system, the set of read requests being received from the host system, the current set of physical memory locations corresponding to a current set of logical memory addresses;
determining whether a read pattern has been detected based on the executing of the set of read requests; and
in response to determining that the read pattern has been detected, performing a prefetch operation on the memory device based on the read pattern, the prefetch operation comprising:
reading next data from a next set of logical memory addresses corresponding to a next set of physical memory locations of the memory device, the next set of logical memory addresses being determined based on the read pattern detected, the reading occurring prior to receiving one or more read requests from the host system to read the next set of logical memory addresses;
based on at least a portion of the information, allocating one or more physical memory locations in the pool for the next data; and
transferring the next data to the one or more physical memory locations.

15. The at least one non-transitory machine-readable storage medium of claim 14, wherein the next set of logical memory addresses is determined based on the read pattern.

16. The at least one non-transitory machine-readable storage medium of claim 14, wherein the operations comprise:
after the transferring of the next data, sending a notification to the host system regarding the next data stored in the pool.

17. The at least one non-transitory machine-readable storage medium of claim 16, wherein the notification indicates where in the pool the next data is stored.

18. The at least one non-transitory machine-readable storage medium of claim 16, wherein the notification indicates the next set of logical memory addresses associated with the next data.

19. The at least one non-transitory machine-readable storage medium of claim 14, wherein the operations comprise:
after the transferring of the next data:
receiving, from the host system, at least one read request for data from at least one logical address included in the next set of logical memory addresses; and
in response to receiving the at least one read request, sending a notification to the host system regarding the next data stored in the pool.

20. A method comprising:
receiving, by a processing device of a memory system and from a host system, information regarding a pool of host memory locations reserved on local memory of the host system;
executing, by the processing device, a set of read requests for reading current data from a current set of physical memory locations of a memory device of a memory system, the set of read requests being received from the host system, the current set of physical memory locations corresponding to a current set of logical memory addresses;
determining, by the processing device, whether a read pattern has been detected based on the executing of the set of read requests; and
in response to determining that the read pattern has been detected, performing, by the processing device, a prefetch operation on the memory device based on the read pattern, the prefetch operation comprising:
reading next data from a next set of logical memory addresses corresponding to a next set of physical memory locations of the memory device, the next set of logical memory addresses being determined based on the read pattern detected, the reading occurring prior to receiving one or more read requests from the host system to read the next set of logical memory addresses;
based on at least a portion of the information, allocating one or more physical memory locations in the pool for the next data; and
transferring the next data to the one or more physical memory locations.
